(19) United States
(12) Patent Application Publication
(10) Pub. No.: US 2020/0339074 A1
(43) Pub. Date: Oct. 29, 2020

(54) CLEANING DEVICE FOR VEHICLES

(71) Applicants: Todd Andrew Reefer, West Sacramento, CA (US); Oliver Douglas Benson, Windsor, CA (US)

(72) Inventors: Todd Andrew Reefer, West Sacramento, CA (US); Oliver Douglas Benson, Windsor, CA (US)

(21) Appl. No.: 16/392,575

(22) Filed: Apr. 23, 2019

(51) Int. Cl. B60S 3/04; B60S 3/00; A47L 13/253

(52) U.S. Cl. CPC B60S 3/044; A47L 13/253; B60S 3/008; B60S 3/047

(57) ABSTRACT

A cleaning device for vehicles is presented. The device has a disposable pad system with pre-applied cleaning chemicals for use on an RV or similar vehicle. The device utilizes a series of disposable textile-based pads. The cleaning aids are envisioned to be made of various textiles such as nylon scrub material for cleaning windows or bugs, a soft microfiber for applying soap or wax and a wool pad for removing wax. The pads are attached to a base approximately four by ten (4×10) inches with a long pole that swivels at the pad connection. The pole can extend to a length of ten (10) feet or retract to two (2) feet for easy storage.

### FIELD OF THE INVENTION

This invention relates to cleaning devices. More particularly, it relates to cleaning devices for vehicles.

### BACKGROUND

A recreational vehicle, often abbreviated as RV, is a motor vehicle or trailer which includes living quarters designed for accommodation. Types of RVs include motorhomes, campervans, caravans (also known as travel traders and camper trailers), fifth-wheel trailers, popup campers and truck campers.

To clean an RV or boat, a mop or swab is used. The mop is a mass or bundle of coarse strings or yarn, etc., or a piece of cloth, sponge, or other absorbent material, attached to a pole or stick. It is used to soak up liquid, for cleaning floors and other surfaces, to mop up dust, or for other cleaning purposes. The word (then spelled mappe) is attested in English as early as 1496, but new refinements and variations of mop designs have been introduced, from time to time.

A wet mop or moist mop is, in professional cleaning, used as in the second step in the cleaning of a surface. The wet mop is swept over the surface to dissolve and absorb fat, mud and dried-in liquid contaminations. Professional wet mops consist of a flat sheet of microfiber textile or a sheet with a surface of looped yarn (which might contain microfiber as well), usually about 15 cm (6 in) wide, and come in various lengths (usually 30-100 cm (12-39 in)).

A mop handle consists of a long piece of wood or aluminum tubing fitted with a specific mount for the mop. The handle can be attached for mounting a mop on it by means of: clamp, hanger (with strands doubled over the hanger), plastic claws (attached to the strands), pouch (as with many professional flat mops), screwing (as with the classic yarn mop), Velcro (as with many professional flat mops).

Mops can be cumbersome and difficult to use when clean an RV. Further, mops are good at wiping dirt and grim but a different head must be utilized to scrub debris off of the RV. Therefore, there is a need to have a mop or swab that can both mop a floor or the outside of an RV but still have a scrubbing mechanism to address those areas that are in need of scrubbing to make pristine.

### BRIEF DESCRIPTION OF THE DRAWINGS

FIG. 1A is an illustrated top view of an exemplary base for a cleaning device.

FIG. 1B is an illustrated side view of the exemplary cleaning device shown in FIG. 1A.

FIG. 1C is an illustrated view of an exemplary pole for use with the exemplary cleaning device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

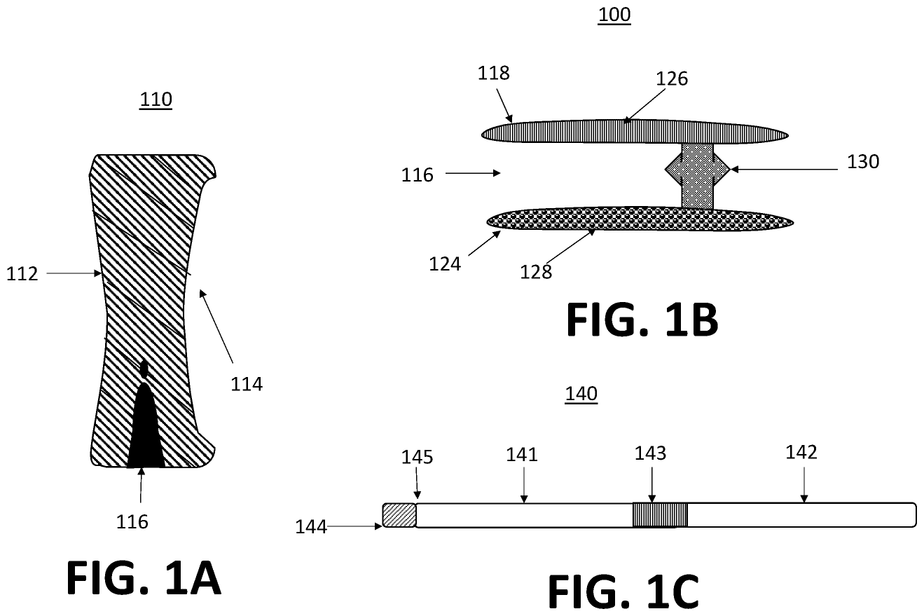

Referring to FIG. 1A, an illustrated view of an exemplary base 110 for a cleaning device 100 for using with vehicles or buildings is presented. The cleaning device 100 is useful for helping to keep recreational vehicles (RVs) and other similar type of vehicles clean and looking their best without using large quantities of water and rinsing. Further, the ease of use of the cleaning device 100 allows for fast, less effort when cleaning and scrubbing the RV or other similar type of vehicle.

The base 110 has a top side 112 and a bottom side 114. The base 110 is useful for holding two (2) cleaning pads (not shown) one of the cleaning pads coupled to the top side 112 of the base 110 and the second pad coupled to the bottom side 114 of the base 100 for cleaning floors or walls.

The base 110 preferably has a length of fourteen (14) inches, but other lengths are contemplated such as, but not limited to, ten (10) inches, sixteen (16) inches, etc. The base 110 preferably has a width of eight (8) inches, but other widths are contemplated such as, but not limited to, six (6) inches, seven and one-half (7.5) inches, nine (9) inches, etc. The base 110 is preferably made of a rigid material such as hard plastic, but other materials are contemplated such as, but not limited to, high-density polyethylene (HDPE), poly-vinyl chloride (PVC), etc.

The base 110 has a cutout 116. The cutout 116 allows for a handle, see FIG. 1C, to move freely and the first pad and second pad to lay flat on the top side 112 of the base 110 and the bottom side 114 of the base 110.

Moving now to FIG. 1B, the exemplary cleaning device 100 is presented from a side view. The base 110 is shown with a first portion 118 and a second portion 124 wherein an open area 122 is between the first portion 118 of the base 110 and the second portion 124 of the base 110.

The first portion 118 of the base 110 of the cleaning device 100 has a first pad 126. The first pad 126 is preferably a scrub pad, but other pads are contemplated such as, but not limited to, a smooth pad, a wet pad, etc. The first pad 118 is preferably removeable and replaceable with a replacement pad.

The second portion 124 of the base 110 of the cleaning device 100 has a second pad 128. The second pad 128 is preferably a soft pad, but other pads are contemplated such as, but not limited to, a smooth pad, a wet pad, etc. The second pad 128 is preferably replaceable, but may be permanent as preferred. The second pad 128 is preferably removable and may be cleaned and reused.

The receiving port 130 is coupled between the first portion 118 of the base 110 and the second portion 124 of the base 110 significantly near the cutout 116 of the base 110. The receiving port 130 is preferably a 360° universal joint but other receiving ports are contemplated such as, but not limited to, a double-sided post connector, a footpad, etc. The receiving port 130 is preferably two (2) inches in diameter, but other diameters are contemplated such as, but not limited to, two and one-fourth (2.25) inch, one and one-half (1.5) inch, etc. The receiving port 130 is preferably a swivel port.

The first pad 126 and the second pad 128 are textile-based and may include a nylon scrub material for cleaning windows or bugs, a soft microfiber for applying soap or wax and a wool pad for removing wax.

The receiving port 130 is preferably a female screw end, but other ends are also contemplated such as, but not limited to, snap-on connector, male screw end, open end with a locking pin, etc. The receiving port 130 is access using the cutout 116 of the cleaning device 100.

Now referring to FIG. 1C, the exemplary pole 140 is presented. The pole 130 is preferably made of an aluminum material, but other materials are contemplated such as, but not limited to, wood, steel, titanium, PVC, HDPE, etc.

The pole 140 has a first portion 141, a second portion 142, a connector 143 and a connecting end 134. The first portion 131 is coupled to the second portion 142 by the connector 143. The first portion 141 may be extended from and retracted into the second portion 142. The connector 143 secures the first portion 141 to the second portion 142 in the determined length. The pole 140 is preferably a length in the range of two to ten (2-10) feet, but other lengths are hereby contemplated.

The connecting end 144 is coupled to a distal end 145 of the pole 140. The connecting end 144 preferably has a diameter of two (2) inches but other diameters are contemplated such as, but not limited to, two and one-fourth (2.25) inch, one and one-half (1.5) inch, etc. The connecting end 144 is preferably a male end screw end, but other types of ends are hereby contemplated.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cleaning device for vehicles, the device comprising:
a base, the base being for coupling a first pad and a second pad;
the first pad being coupled to a first side of the base;
the second pad being coupled to a second side of the base;
a receiving port for receiving a pole; wherein the receiving port being coupled between the first pad and the second pad and wherein the receiving port being a swivel; and
wherein the pole being extendable, wherein the pole being extended for reaching far areas and retractable for storage.

2. The device of claim 1, wherein the base having a length of fourteen (14) inches.

3. The device of claim 1, wherein the base having a width of eight (8) inches.

4. The device of claim 1, wherein the first pad being a textile-based pad.

5. The device of claim 4, wherein the textile-based pad being a soft microfiber.

6. The device of claim 1, wherein the second pad being a textile-based pad.

7. The device of claim 7, wherein the textile-based pad being a nylon scrub material.

8. The device of claim 1, wherein the pole having a maximum length of ten (10) feet.

9. The device of claim 1, wherein the pole having a minimum length of two (2) feet.

10. The device system of claim 1, wherein the first pad being disposable.

11. The device system of claim 1, wherein the first pad being disposable.

12. The device of claim 1, wherein the first pad being removable.

13. The device of claim 1, wherein the second pad being removable.

14. The device of claim 1, wherein the base being made of a hard-plastic material.

15. The device of claim 1, wherein the pole being made of aluminum.
